(19) United States
(12) Patent Application Publication
(10) Pub. No.: US 2009/0221179 A1
(43) Pub. Date: Sep. 3, 2009

(54) TAMPER RESISTANT FACEPLATE SYSTEM

(76) Inventor: Arnel Berton CITURS, Omaha, NE (US)

Correspondence Address: Muncy, Geissler, Olds & Lowe, PLLC, P.O. BOX 1364, FAIRFAX, VA, 22038-1364, US

(21) Appl. No.: 12/039,577

(22) Filed: Feb. 28, 2008

(51) Int. Cl. H01R 13/66

(52) U.S. Cl. 439/536

(57) ABSTRACT

A tamper resistant faceplate assembly includes a faceplate base and a removably attached cover. The faceplate base presents ports (such as RJ-type jacks, fiber optic couplers and/or coaxial F-type connectors) at a downwardly directed angle. The cover includes several cable holes near its bottom. The cable holes are size to permit passage of a cable, but to exclude passage of a connector and/or to restrict the insertion of a finger or use of a tool to install/remove a connector. The cover is attached to the faceplate base by a snap-locking engagement, but may be further secured to the faceplate base by a screw or security fastener. The cover deters unauthorized connections and disconnections of connectors to communication networks via the ports of the faceplate base.

### BACKGROUND OF THE INVENTION

1. Field of the Invention

The present invention relates to communication connectors. More particularly, the present invention relates to a faceplate assembly for holding one or more connectors or ports, wherein the faceplate assembly includes structures to limit access to the ports in order to resist unauthorized connection to, or disconnection from, a port of the faceplate assembly.

2. Description of the Related Art

Communications cables, such as shielded and unshielded twisted pair cables, coaxial cables, and fiber optic cables, transmit data, voice, video and/or audio information in the telecommunications industry. Such cables are commonly used in homes, office buildings, school, hospitals, etc. as links to communication networks.

In one example, a communication cable (such as a twisted pair cable, coaxial cable, or fiber optic cable) may be run within a wall, ceiling or conduit and into a single-gang or double-gang connection box, mounted to a wall stud. The communication cable is then terminated to a connector (such as an RJ-type jack, F-type coaxial connector, or LC or SC adapter). The connector is mounted to a faceplate, and the faceplate is attached to the connection box (such as a single-gang or double-gang outlet box) by screws. U.S. Pat. Nos. 5,961,345 and 6,793,524, which are incorporated herein by reference, illustrate a typical connection box, connectors and faceplate combination.

As seen in the prior art structure of FIGS. 1-3, a holder 50 receives an RJ-type jack connector 62 and two coaxial F-type connectors 60. A plastic faceplate 30 is attached to the holder 50 via two screws 70, passing through holes 72 formed in the faceplate 30. Bezels 40, 41, 42 are interposed between the connectors 60, 62 and the faceplate 30 in order to size the connectors 60, 62 to an opening 35 in the faceplate 30. The holder/faceplate assembly 10 is ultimately connected to a single-gang box 20 (which could be attached to a wall stud).

### SUMMARY OF THE INVENTION

The Applicant has appreciated one or more drawbacks of the faceplate designs of the prior art. For example, in certain situations, network connectors may be provided in rooms generally accessible to the public, e.g., hospital rooms, hotel rooms and classrooms. The Applicant appreciated that the faceplate needed features to deter and/or resist an unauthorized person from directly accessing a communication network via a port of the faceplate, and to also deter and/or resist an unauthorized person from disconnecting a device from a network port of the faceplate.

An example of the former undesirable situation might be where a visitor in a hospital room connects a laptop computer into a network jack on the wall in the hospital room. The visitor could corrupt the hospital's network by introducing a virus into the network. An example of the latter undesirable situation might be where a child in a classroom mischievously unplugs a classroom computer from the school's network. A further combined example might be in a hotel room where a TV wall jack is connected to a monitoring device by a first patch cord, which is in turn connected to a TV by a second patch cord. A guest might attempt to bypass the monitoring device by unplugging the monitoring device from the TV wall jack and directly connecting the TV to the wall jack.

It is an object of the present invention to provide a faceplate assembly to overcome one or more of the Applicant's appreciated drawbacks.

These and other objects are accomplished by a tamper resistant faceplate assembly including a faceplate base and a removably attached cover. The faceplate base presents ports (such as RJ-type jacks, fiber optic couplers and/or coaxial F-type connectors) at a downwardly directed angle. The cover includes several cable holes near its bottom. The cable holes are size to permit passage of a cable, but to exclude passage of a connector and/or restrict the insertion of a finger or use of a tool to install/remove a connector. The cover is attached to the faceplate base by a snap-locking engagement, but may be further secured to the faceplate base by a screw or security fastener. The cover can deter unauthorized connections and disconnections of connectors to communication networks via the ports of the faceplate base.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is an exploded view of a connection box and a faceplate assembly for presenting communication ports, in accordance with the prior art;

FIG. 2 is a front perspective view of the faceplate assembly of FIG. 1;

FIG. 3 is a rear perspective view of the faceplate assembly of FIG. 1;

FIG. 4 is a perspective view of a faceplate base of a faceplate assembly, in accordance with the present invention;

FIG. 5 is a side view of the faceplate base, as viewed from line V-V in FIG. 4;

FIG. 6 is a front view of the faceplate base of FIG. 4;

FIG. 7 is a cross sectional view taken along line VII-VII of FIG. 6;

FIG. 8 is a cross sectional view taken along line VIII-VIII of FIG. 6;

FIG. 9 is a perspective view of a cover of the faceplate assembly, in accordance with the present invention;

FIG. 10 is a perspective view of an enlarged, alternative cover of the faceplate assembly, in accordance with the present invention;

FIG. 11 is a front view of the cover of FIG. 9;

FIG. 12 is a top view of the cover of FIG. 11;

FIG. 13 is a bottom view of the cover of FIG. 11;

FIG. 14 is a left side view of the cover of FIG. 11;

FIG. 15 is a right side view of the cover of FIG. 11;

FIG. 16 is a back view of the cover of FIG. 11;

FIG. 17 is an enlarged view of a latching mechanism of the cover of FIG. 16;

FIG. 18 is an exploded view of a bezel for mounting various combinations of ports or blank plates; and

FIG. 19 is an exploded view of the faceplate assembly, illustrating the attachments between the faceplate base, the cover and possible indicia inserts and snap-in indicators.

### DETAILED DESCRIPTION OF A PREFERRED EMBODIMENT

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

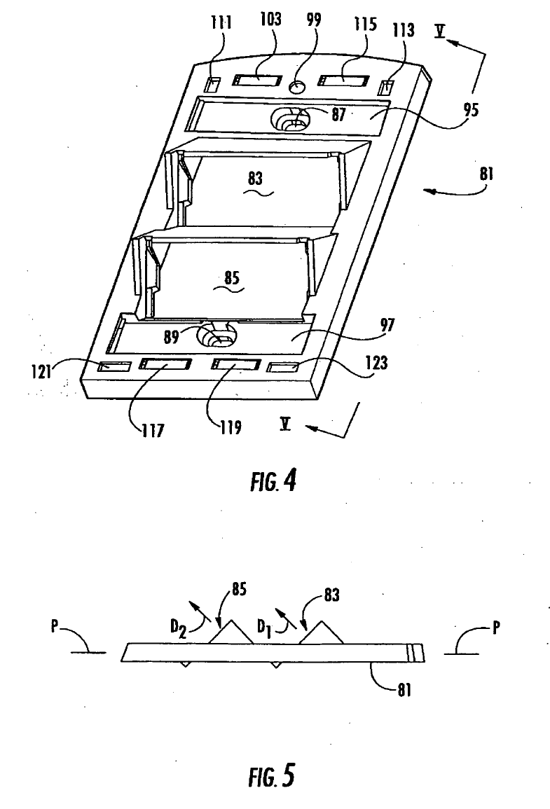

FIG. 4 is perspective view of a faceplate base 81 in accordance with the present invention. The faceplate base 81 is preferably formed by a molding process of PC/ABS plastic. As best seen in FIG. 5, the faceplate base 81 generally resides in a first plane P and includes a first passage 83 and a second passage 85. The first passage 83 extends in a direction D1 which is angled relative to the first plane P, and the second passage 85 extends in a direction D2 which is also angled relative to the first plane P. In a preferred embodiment, the first and second directions D1 and D2 extend at an angle of approximately 45 degrees relative to the first plane P. However, the first and second directions D1 and D2 need not be angled to the same extent relative to the first plane P, and the angles need not be exactly 45 degrees, e.g., 35 degrees or 55 degrees would be acceptable angles.

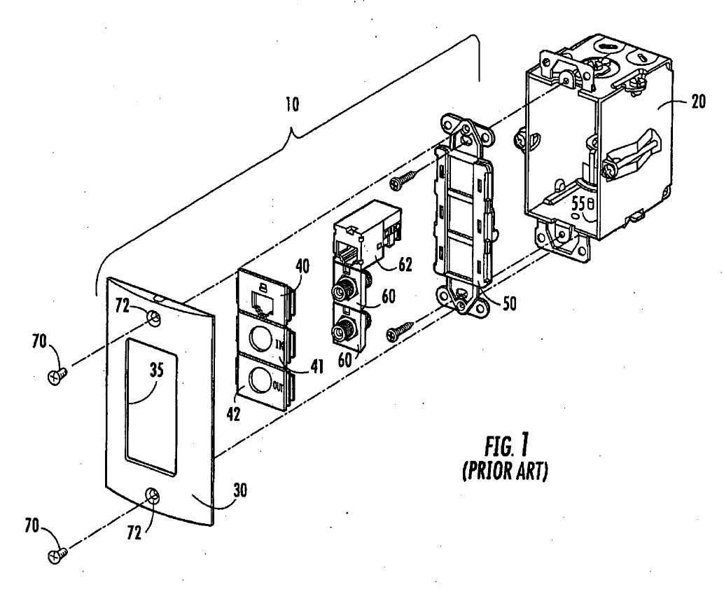

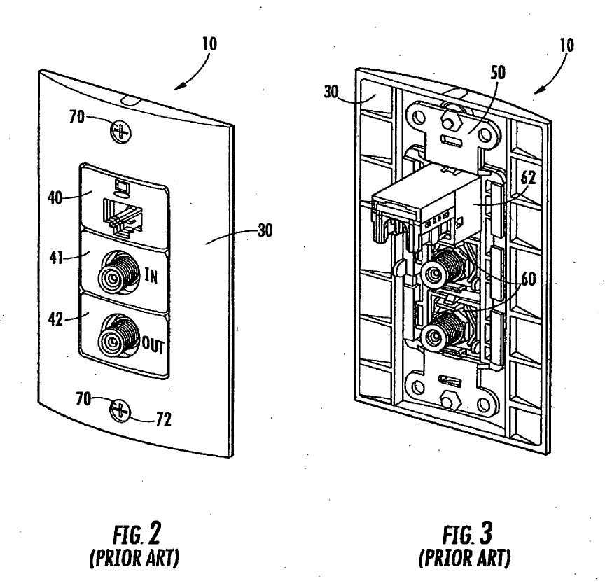

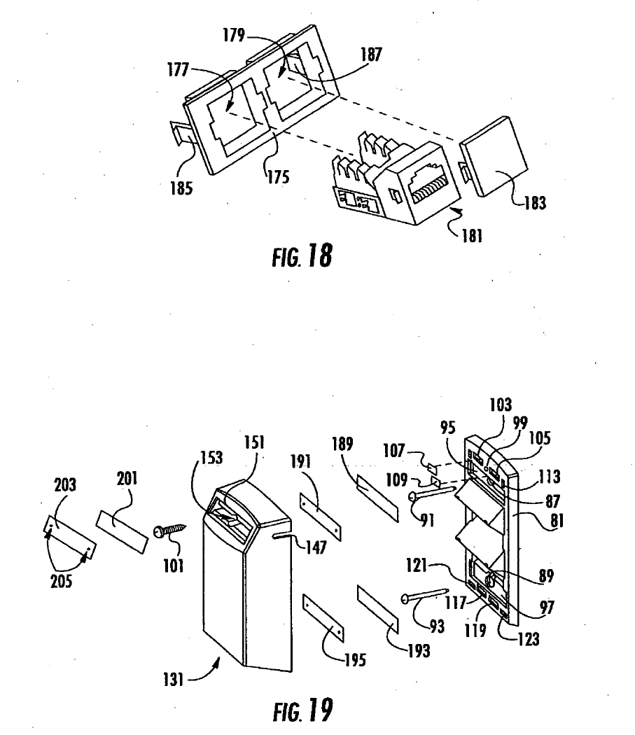

The faceplate base 81 also includes a first through hole 87 and a second through hole 89 spaced apart in the illustrated embodiment, by approximately 3.28 inches. The first and second through holes 87 and 89 are sized to receive screws 91 and 93 (See FIG. 19) to connect the faceplate base 81 to a connection box (similar to the connection box 20 illustrated in FIG. 1). The first and second through holes 87 and 89 are countersunk into the plastic material of the faceplate base 81. The countersinking allows the heads of the screws 91 and 93 to be at a same level or slightly lower than a level of first and second indicia receiving surfaces 95 and 97.

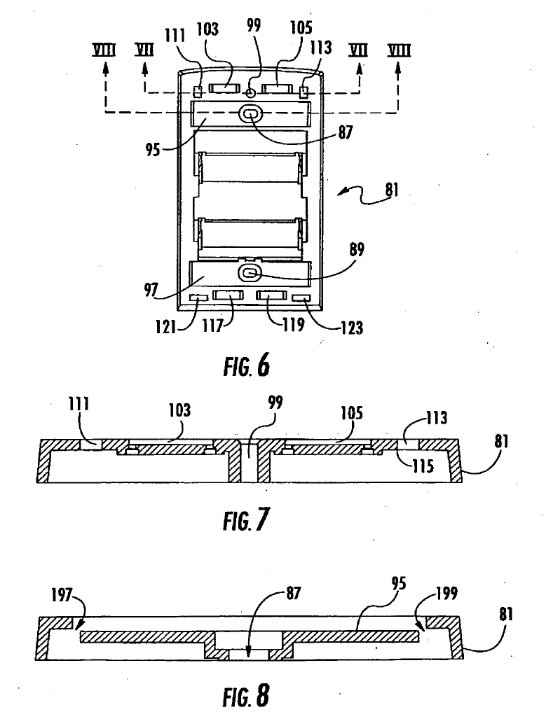

As best seen in FIG. 6 and the cross-sectional view of FIG. 7, an upper portion of the faceplate base 81 includes a third through hole 99. The third through hole 99 is located along a central line of the faceplate base 81 and receives a threaded fastener 101, as will be further discussed with reference to FIG. 19.

To the right and left of the third through hole 99 are first and second recessed portions 103 and 105. The first and second recessed portions 103 and 105 receive snap-in indicator panels 107 and 109, as will be further discussed with reference to FIG. 19.

To the right and left of the first and second recessed portions 103 and 105 are fourth and fifth through holes 111 and 113. The fourth and fifth through holes 111 and 113 are rectangular in shape. The fifth through hole 113 presents a ledge 115 which will be used to secure a cover to the faceplate base 81, as will be discussed hereinafter.

The lower portion of the faceplate base 81 includes third and fourth recessed portions 117 and 119 to receive snap-in indicator panels, as will be further discussed with reference to FIG. 19. The lower portion may also include sixth and seventh through holes 121 and 123 of a rectangular shape.

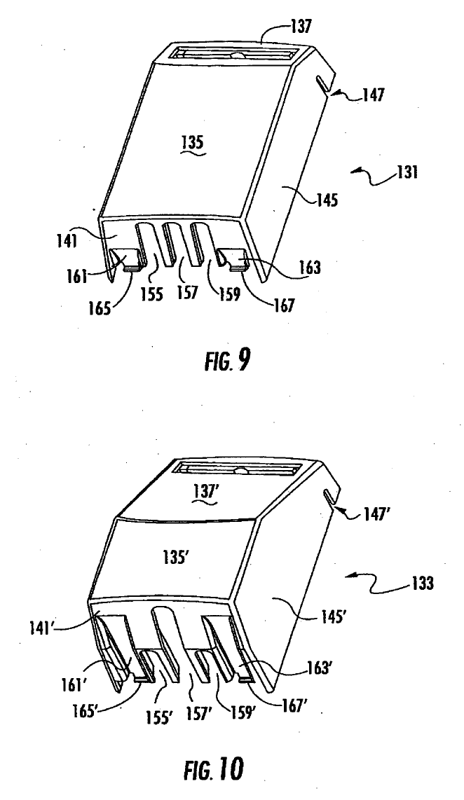

FIG. 9 is a perspective view of a first cover 131 for attachment to the faceplate base 81. FIG. 10 is a perspective view of an alternative, second cover 133 for attachment to the faceplate base 81. Other than the difference in the depth, the first and second covers 131 and 133 have the same or similar features, such as attachment features. Therefore, a detailed explanation of the first cover 131 will follow, with the understanding that the same principals apply to the second cover 133, wherein like elements are labeled with the same reference numeral followed by a prime (′) indicator.

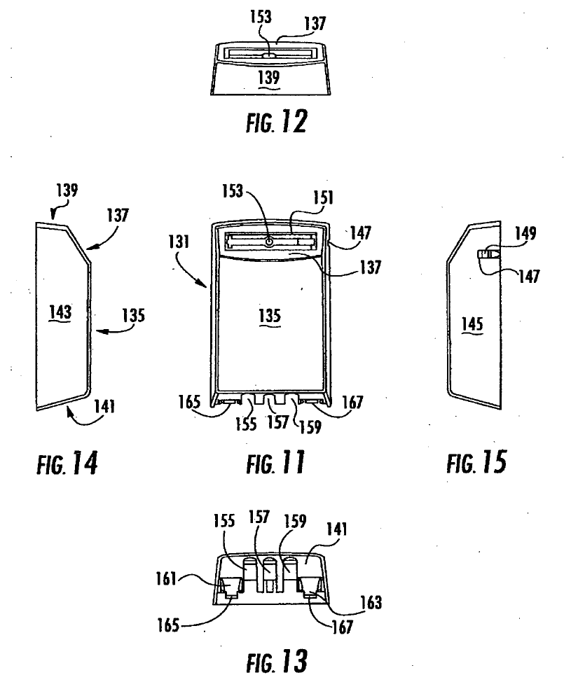

FIGS. 11-15 illustrate the front, top, bottom, left side and right side of the first cover 131, respectively. The first cover 131 includes a front panel 135, an angled viewing panel 137, a top panel 139, a bottom panel 141, a left panel 143 and a right panel 145. The viewing panel 137 is so-called because it is at the best angle to be seen by a person looking at the cover 131, when the cover 131 is attached to a faceplate base 81 attached to a lower section of a wall. In a preferred embodiment, the entire cover 131 is formed of a transparent material. However, it is also possible to form only the viewing panel 137 and/or the front panel 135 of a transparent material.

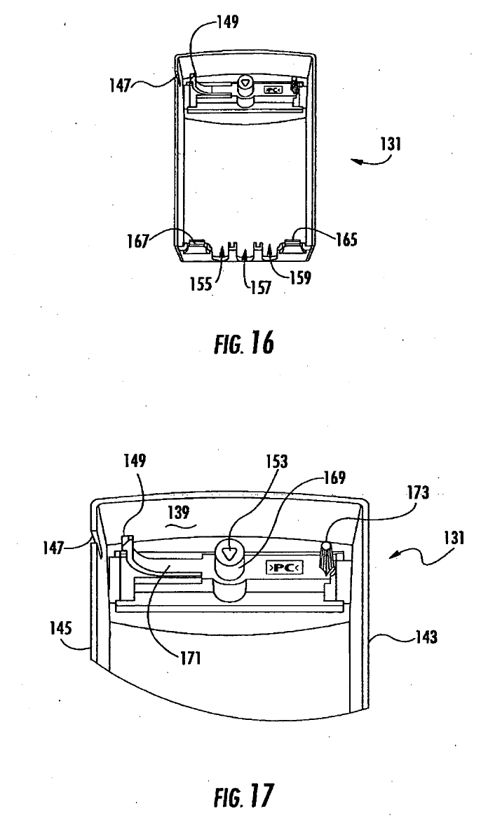

As best seen in FIGS. 11, 12, and 14, the front panel 135, top panel 139, and left side panel 143 are substantially planar members without features. The front panel 135, top panel 139 and left side panel 143 provide no access to the faceplate base 81 when the cover 131 is mounted to the faceplate base 81. As best seen in FIG. 15, the right side panel 145 includes a through slot 147. The through slot 147 provides access to a deflectable hook 149, mounted within the cover 131, as will be described in conjunction with FIGS. 16 and 17.

The viewing panel 137 includes an indicia receiving area 151. In the center of the indicia receiving area 151 resides a fastener hole 153. The fastener hole 153 is sized to allow passage therethrough of the threaded fastener 101 for engaging the third through hole 99 of the faceplate base 81 to secure the cover 131 to the faceplate base 81.

The bottom panel 141 includes one or more cable holes penetrating therethrough. In the illustrated embodiment, first, second and third cable holes 155, 157, and 159 reside within the bottom panel 141, and each hole extends completely to the side edge to form a slot. Each of the first, second and third cable holes 155, 157 and 159 is large enough to allow passage of a cable. However in one embodiment, none of the first, second and third cable holes 155, 157 and 159 is large enough to allow passage of a connector attached to that cable for mating with a port on the faceplate base 81, as will be further described in relation to FIGS. 18 and 19.

As best seen in FIG. 9, the bottom panel 141 also includes a first tab 161 and a second tab 163. The first tab 161 is sized to fit into the sixth through hole 121 and includes a first protrusion 165, which is intended to engage on a lower inside lip of the sixth through hole 121. The second tab 163 is sized to fit into the seventh through hole 123 and includes a second protrusion 167, which is intended to engage on a lower inside lip of the seventh through hole 123.

FIG. 16 shows the rear of the cover 131 and FIG. 17 is a close-up view of the upper portion of the rear of the cover 131. Immediately behind the indicia receiving area 151 resides a snap-locking arrangement. The snap-locking arrangement includes a boss 169. The fastener hole 153 passes through a center of the boss 169. The boss 169 supports a flexible and resilient bowed member 171. The bowed member 171 has the deflectable hook 149 at its distal end. The bowed member may be formed of such materials as plastic or spring steel. A stand-off 173 resides at the opposed distal end of the bowed member 171.

Now with reference to FIGS. 18 and 19, one embodiment of an assembly of the various component parts of the tamper resistant faceplate system of the present invention will be described. As illustrated in FIG. 18, a bezel 175 has first and second openings 177 and 179. The openings 177 and 179 are sized to accept modular ports in a snap-locking manner (such as an RJ-type jack 181, a fiber optic coupler, a coaxial F-type connector). The openings 177 and 179 are also sized to receive a blank plate 183 in a snap-locking manner, if desired. The bezel may also be designed to have only one centrally located opening to receive a modular port or blank plate in a snap-locking manner.

The bezel 175 includes opposed locking tabs 185 and 187. The locking tabs 185 and 187 are formed of a resilient and flexible material and include projections to snap-lock into or behind the sidewalls of either the first or second passages 83 or 85. By this arrangement, the ports may be mounted such that their faces are downwardly angled relative to the plane P of the faceplate base 81 by an angle of approximately 45 degrees.

As illustrated in FIG. 19, the faceplate base 81 is then mounted to a connection box via screws 91 and 93 passing through the first and second through holes 87 and 89, respectively. After, the screws 91 and 93 are recessed into the counter-sunk first and second through holes 87 and 89, a first planar member 189, which may contain indicia, is placed over the first indicia receiving surface 95 to conceal the head of the upper screw 91. Then, a transparent plastic cover, such as a first clear protective sheet 191, is bowed by finger pressure and placed over the first planar member 189. The first clear protective sheet 191 is retained in its position over the first planar member 189 by its ends extending into opposed pockets 197 and 199 (See FIG. 8) after the finger pressure is released and the first clear protective sheet 191 returns to its naturally flat state. Likewise, a second planar member 193, which may contain indicia, is placed over the second indicia receiving surface 97 to conceal the head of the lower screw 93. Then, a second clear protective sheet 195 is placed over the second planar member 193.

Additional indicia relating the type of the ports, or networks served by the ports, may be provided by mounting snap-in indicator panels 107 and 109 into the first and second recessed portions 103 and 105. Additional indicator panels may be snapped into the third and fourth recessed portions 117 and 119, if desired. The indicator panels may be color coded, molded pieces of plastic, and may optionally indicate words such as “DATA” “VOICE “VIDEO” “SECURITY” or “AUDIO”. Once the faceplate base 81 has been assembled with ports, attached to a connection box, and the desired indicia has been mounted thereon, the user attaches the connectors to the ports.

Finally, a cover 131 or 133 may be mounted to the faceplate base 81. The user selects the desired cover 131 or 133 based upon the type of ports installed, the nature of the connectors that will attach to the ports and the permissible bend radii of cables attached to the connectors. If a port is used which extends a long distance away from the bezel 175 (like an F-type connector 60 as illustrated in FIG. 1), or a connector is used which has an extended length (like some compression style coaxial connectors and some fiber optic connectors), or a cable is used which requires a large bend radius (like a coaxial cable or a particular type of fiber optic cable), then the larger depth cover 133 is selected. Otherwise, the default choice is the smaller depth cover 131.

Initially, the cables are inserted into the first, second and third cable holes 155, 157 and 159 of the cover 131. Next, the first and second tabs 161 and 163 are inserted into the sixth and seventh through holes 121 and 123 until the first and second protrusions 165 and 167 engage over lower inside lips of the sixth and seventh through holes 121 and 123. Then, the cover 131 is pivoted upward until the deflectable hook 149 enters into the fifth through hole 113 and engages behind the ledge 115 residing on the inner right side of the fifth through hole 113 with a snapping action. At this point the cover 131 is secured to the faceplate base 81.

A further security measure may be accomplished by inserting the threaded fastener 101 (such as a Phillips screw or a threaded fastener having a security head thereon, like a hex head or a tamper resistant hex head) through the fastener hole 153. The threads of the threaded faster 101 would engage with the sidewalls of the third through hole 99 of the faceplate base 81.

The head of the threaded fastener 101 could be concealed by a third planar member 201, which may contain indicia. The third planar member 201 would be placed over the indicia receiving area 151. Then, a third clear protective sheet 203 would be bowed by finger pressure and placed over the third planar member 201. The third clear protective sheet 203 would be retained in its position over the third planar member 201, by its ends extending into opposed pockets (like the pockets 197 and 199 in FIG. 8) after the finger pressure is released and the third clear protective sheet 203 returns to its naturally flat state.

To remove the cover 131, the user may utilize the small holes 205 in the third clear protective sheet 203 to bow the sheet material and remove it from the third planar member 201. The third planar member 201 may then be removed by a user's finger nail. A screw driver or driver with a security head feature would be used to remove the threaded fastener 101. Then, a small elongated object, like a flat bladed jeweler's screw driver, would be inserted into the through slot 147 to press against the deflectable hook 149 and dislodge it from the ledge 115. Once dislodged, the cover 131 may be pivoted downward about an axis formed by the first and second protrusions 165 and 167. Finally, the first and second tabs 161 and 163 may be removed from the sixth and seventh through holes 121 and 123.

By the present invention, the cover 131 may be removably attached to the faceplate base 81, so that the cover 131 blocks access to ports 181 except though one or more cable holes 155, 157, 159 penetrating said cover 131. In one embodiment, each of the one or more cable holes 155, 157, 159 has a width of less than or equal to about 0.43 inches. In another embodiment, each of the one or more cable holes 155, 157, 159 has a width of less than or equal to about 0.36 inches. Such dimensions allow for passage of cable diameters of normal size (or large diameter cables in the case of holes with a width of 0.43 inches), yet prevent the insertion or removal of a connector and/or prevent the insertion of a person's finger so as to access the ports mounted to the faceplate base 81. Further, by forming at least a portion of the cover 131 of a transparent material, a user may view indicia located on the faceplate base 81 to discern the nature of the existing or potential network connections existing within the cover 131.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

We claim:

1. A tamper resistant faceplate assembly for presenting at least one port to receive a mating connector of a cable to establish a connection to a communication network associated with the at least one port, said faceplate assembly comprising:
a faceplate base having at least one passage;
at least one port, exposed through said at least one passage in said faceplate base; and
a cover attached to said faceplate base, said cover blocking access to said at least one port except though one or more cable holes penetrating said cover, wherein at least one of said one or more cable holes is large enough to allow passage of the cable, and wherein none of said one or more cable holes is large enough to allow passage of the connector for mating with said port and/or to allow the insertion of a finger or use of a tool to install/remove a connector.

2. The tamper resistant faceplate assembly of claim 1, wherein said cover is at least partially formed of a transparent material to allow viewing of at least a portion of said faceplate base through said cover.

3. The tamper resistant faceplate assembly of claim 1, wherein said cover is removably attached to said faceplate base by snap-locking features.

4. The tamper resistant faceplate assembly of claim 1, wherein said cover includes a fastener hole, and further comprising:
a threaded fastener passing through said fastener hole and engaging a portion of said faceplate base to secure said cover to said faceplate base.

5. The tamper resistant faceplate assembly of claim 1, wherein said cover is attached to said faceplate base by a deflectable hook, and wherein said cover or said faceplate base includes a through slot aligned with said deflectable hook, such that an elongated object may be inserted into said through slot to press against said deflectable hook and detach said cover from said faceplate base.

6. The tamper resistant faceplate assembly of claim 5, wherein said cover includes said deflectable hook and said through slot, and wherein said faceplate base includes a ledge to retain said deflectable hook when said cover is attached to said faceplate base.

7. The tamper resistant faceplate assembly of claim 1, wherein said faceplate base generally resides in a first plane, and wherein said at least one passage extends in a direction which is angled relative to the first plane, such that a face of said at least one port is angled relative to the first plane.

8. The tamper resistant faceplate assembly of claim 7, wherein said face of said at least one port is angled at approximately 45 degrees relative to said first plane.

9. The tamper resistant faceplate assembly of claim 1, wherein said faceplate base includes a first through hole and a second through hole spaced apart by approximately 3.28 inches for receiving screws to connect said faceplate base to the connection box.

10. The tamper resistant faceplate assembly of claim 9, wherein said faceplate base includes an area for receiving indicia, and wherein said area overlies one of said first through hole and said second through hole.

11. The tamper resistant faceplate assembly of claim 1, wherein said cover includes an indicia receiving area and a transparent plastic cover removably secured over said indicia receiving area.

12. The tamper resistant faceplate assembly of claim 1, wherein said cover includes a fastener hole, and further comprising:
a threaded fastener passing through said fastener hole and engaging a portion of said faceplate base to secure said cover to said faceplate base, wherein said cover includes an indicia receiving area, and wherein said indicia receiving area overlies said fastener hole.

13. The tamper resistant faceplate assembly of claim 1, further comprising:
a plurality of recessed portions formed in said faceplate base for receiving respective snap-in indicator panels.

14. The tamper resistant faceplate assembly of claim 1, wherein each of said one or more cable holes has a width of less than about 0.43 inches.

15. A tamper resistant faceplate assembly for presenting at least one port to receive a mating connector of a cable to establish a connection to a communication network associated with the at least one port, said faceplate assembly comprising:
a faceplate base having at least one passage to accept at least one port;
a cover removably attached to said faceplate base, said cover for blocking access to the at least one port except though one or more cable holes penetrating said cover, wherein said cover includes at least one tab proximate a first end of said cover and a hook distanced from said at least one tab, and wherein said faceplate base includes at least one hole receiving said at least one tab and a ledge engaging said hook, such that said cover may be initially pivoted about said at least one tab when seated in said at least one hole, until said hook snap locks onto said ledge to secure said cover to said faceplate base.

16. The tamper resistant faceplate assembly of claim 15, wherein said at least one tab includes a first tab and a second tab and wherein said at least one hole includes a first hole and a second hole, such that said cover may be initially pivoted about said first and second tabs when seated in said first and second holes, until said hook snap locks onto said ledge to secure said cover to said faceplate base.

17. The tamper resistant faceplate assembly of claim 15, wherein said cover is at least partially formed of a transparent material to allow viewing of at least a portion of said faceplate base through said cover.

18. The tamper resistant faceplate assembly of claim 15, wherein said cover includes a fastener hole, and further comprising:
a threaded fastener passing through said fastener hole and engaging a portion of said faceplate base to secure said cover to said faceplate base.

19. The tamper resistant faceplate assembly of claim 15, wherein said cover includes a through slot aligned with said hook, such that an elongated object may be inserted into said through slot to press against and deflect said hook away from said ledge of said faceplate base and detach said cover from said faceplate base.

20. The tamper resistant faceplate assembly of claim 15, wherein said faceplate base generally resides in a first plane, and wherein said at least one passage extends in a direction which is angled relative to the first plane, such that a face of the at least one port is angled relative to the first plane.

21. A tamper resistant faceplate assembly for presenting at least one port to receive a mating connector of a cable to establish a connection to a communication network associated with the at least one port, said faceplate assembly comprising:
a faceplate base having at least one passage;
at least one port, exposed through said at least one passage in said faceplate base; and
a cover removably attached to said faceplate base, said cover blocking access to said at least one port except though one or more cable holes penetrating said cover, wherein at least one of said one or more cable holes is large enough to allow passage of the cable, wherein none of said one or more cable holes is large enough to allow passage of the connector for mating with said port and/or to allow the insertion of a finger or use of a tool to install/remove a connector, wherein said cover includes at least one tab proximate a first end of said cover and a hook distanced from said at least one tab, and wherein said faceplate base includes at least one hole receiving said at least one tab and a ledge engaging said hook, such that said cover may be initially pivoted about said at least one tab when seated in said at least one hole, until said hook snap locks onto said ledge to secure said cover to said faceplate base.

22. A tamper resistant faceplate assembly for presenting at least one port to receive a mating connector of a cable to establish a connection to a communication network associated with the at least one port, said faceplate assembly comprising:
a faceplate base having at least one passage;
at least one port, exposed through said at least one passage in said faceplate base; and
a cover attached to said faceplate base, said cover blocking access to said at least one port except though one or more cable holes penetrating said cover, wherein at least one of said one or more cable holes is large enough to allow passage of the cable, and wherein none of said one or more cable holes is large enough to allow passage of the connector for mating with said port.
